(19) United States
(12) Patent Application Publication
(10) Pub. No.: US 2009/0276653 A1
(43) Pub. Date: Nov. 5, 2009

(54) Presence server for discrete time updates

(76) Inventors: Ramesh V. Pattabhiraman, New Albany, OH (US); Kumar V. Vemuri, Cambridge, MA (US)

Correspondence Address: Carmen Patti Law Group, LLC, One N. LaSalle Street, 44th Floor, Chicago, IL, 60602, US

(21) Appl. No.: 12/151,055

(22) Filed: May 2, 2008

(51) Int. Cl. G06F 1/14; G06F 15/16

(52) U.S. Cl. 713/502; 709/204

(57) ABSTRACT

A presence server of an apparatus in one example is configured to receive at least one event message from a network entity in continuous time. The presence server is configured to determine at discrete time intervals if an update message should be sent for the network entity. The discrete time intervals comprise instances of an epoch. The presence server is configured to determine if the update message should be sent upon an epoch boundary. The presence server is configured to dynamically determine a duration of the epoch.

### TECHNICAL FIELD

The invention relates generally to telecommunications and more particularly to high availability networks.

### BACKGROUND

Telephony services require support for “carrier grade solutions” which provide high availability and high reliability characteristics. Typical system availability is measured in “9's”, where the number of nines indicates the permitted availability per year. For example, “five 9's” indicates 99.999% uptime or approximately 5 minutes, 15 seconds of downtime per year.

Several solutions are prevalent today to help build such high availability carrier-grade architectures. These include active-standby, active-active, and N+K arrangements of servers. In the last case in particular, a parallel redundancy model is used along with Markov Chain analysis to support a complex of N+K servers, N of which are required for capacity, and K for the desired redundancy, with the cluster as a whole showing no loss of overall capacity for up to K concurrent failures.

As one approach for improving availability and capacity, limitations may be placed on message throughput among servers. Some solutions employ rate-limiting which may require the maintenance of a timer on a per subscriber basis and processing of event aggregations in keeping with that timer. The load experienced by the server increases along with the number of subscribers.

### SUMMARY

The invention in one implementation encompasses an apparatus. The apparatus comprises a presence server configured to receive at least one event message from a network entity in continuous time. The presence server is configured to determine at discrete time intervals if an update message should be sent for the network entity. The discrete time intervals comprise instances of an epoch. The presence server is configured to determine if the update message should be sent upon an epoch boundary. The presence server is configured to dynamically determine a duration of the epoch.

Another implementation of the invention encompasses a method. A plurality of event messages are received from a network entity in continuous time during an epoch. The epoch comprises a discrete time interval. A duration of the epoch is dynamically determined. A determination is made if an update message should be sent for the network entity upon an epoch boundary of the epoch.

A further implementation of the invention encompasses an article. The article comprises one or more computer-readable signal-bearing media. The article includes means in the one or more media for receiving a plurality of event messages from a network entity in continuous time during an epoch. The epoch comprises a discrete time interval. The article further comprises means in the one or more media for dynamically determining a duration of the epoch. The article also comprises means in the one or more media for determining if an update message should be sent for the network entity upon an epoch boundary of the epoch.

### DESCRIPTION OF THE DRAWINGS

Features of example implementations of the invention will become apparent from the description, the claims, and the accompanying drawings in which:

FIG. 1 is a representation of one implementation of an apparatus that comprises a communication network with a presence server, one or more entities, and one or more watchers.

FIG. 2 is a representation of one implementation of a logic flow for the presence server of FIG. 1.

FIG. 3 is a representation of one implementation of a message flow between the presence server, entities, and watchers of FIG. 1.

FIG. 4 is a representation of another implementation of the communication network with a presence server cluster.

FIG. 5 is a representation of one implementation of a message flow for the presence server cluster of FIG. 4.

### DETAILED DESCRIPTION

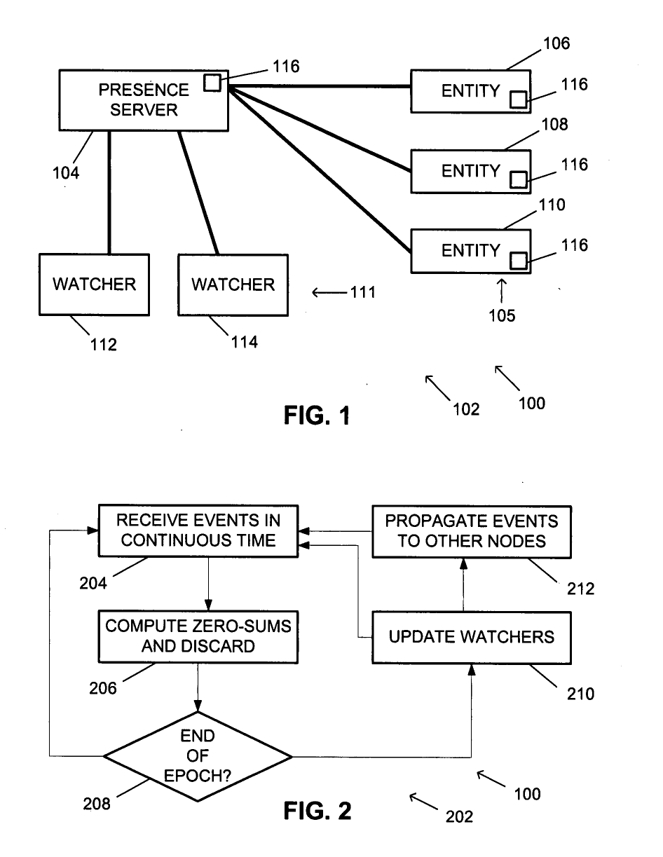

Turning to FIG. 1, an apparatus 100 in one example comprises a communication network 102 with a presence server 104, one or more entities 105 (e.g., network entities), and one or more watchers 111. One or more of the presence server 104 and the entities 105 in one example comprise an instance of a recordable data storage medium 116. The entities 105, (i.e. entities 106, 108, and 110) in one example are members of the communication network 102. Examples of the entities 105 and watchers 111 comprise mobile phones, client computers, instant messenger clients, other user communication devices or modules, logical entities, network resources, or applications. In another example, the entities 105 comprise identifiers for people (e.g., a person using an instant messaging program), roles (e.g., a helpdesk or support service), or resources (e.g., a conference room or meeting area). The entities 105 in one example are entities whose presence is of interest to the presence server 104 and/or the watchers 111, for example, “presentities” as defined in IETF SIMPLE, or “principles” as defined in RFC2778. The entities 105 in one example send events or event messages (e.g., presence updates) to the presence server 104. In another example, the presence server 104 obtains the events from the entities 105. While references to “presence” and status variables of the entities is mentioned, alternative implementations are possible, for example, where the apparatus 100 is configured to handle event processing and event distribution in other distributed systems, as will be appreciated by those skilled in the art.

The entities 105 in one example send the event messages to the presence server 104 to update a status variable. Examples of status variables comprise the entity's connection status (e.g., connected, disconnected, registered), connection type to the network (e.g., Wi-Fi, broadband, cellular, or other wireless technologies), the location, availability (e.g., occupied, available), or other indicators. The status variables in one example are user-definable by a user of the entity, for example, status indicators such as “away from my desk” or “not taking calls”.

The presence server 104 in one example is configured to receive the events from the entities 105 and send updates to the watchers 111. The watchers 111 in one example comprise watchers 112 and 114. The watchers 111 comprise entities that watch the entities 105. The presence server 104 in one example formats and sends an update for the entities 105 to the watchers 111. The presence server 104 in one example comprises a service or software module executed by an application server. For example, the presence server 104 could be implemented as an event aggregation engine. In another example, the presence server 104 comprises a standalone network server.

The watchers 111 in one example subscribe to the entities 105 that they are interested in. For example, the watcher 112 may subscribe to entities 106 and 110 and the watcher 114 may subscribe to entities 108 and 110. The watchers 111 send a message to the presence server 104 to indicate their interest. The presence server 104 then sends the corresponding updates to the watchers 111. The watchers 111 may send an unsubscribe message to discontinue receipt of the update messages, as will be appreciated by those skilled in the art.

Events at the entities 105 may occur at any time and are reported to the presence server 104. In one example, the entities 105 report the events in real-time as they occur. If the presence server 104 processes each event from the entities 105 as they arrive and sends the updates to the watchers 111 (e.g., a “continuous time” approach), several issues may arise. A first issue may be due to conflicting events received within a small interval would each result in a separate update for each watcher. In this approach, events which sum to zero would still be reported, which results in an increase in network traffic. For example, if the presence server 104 receives a “disconnected” event shortly followed by a “connected” event followed by another disconnected event from the entity 106, the last two events (connected and disconnected) may cancel each other out. A second potential issue is that different watchers 111 may see different states for the same entity at a given time. A third issue is that if loads on the communication network 102 occur in spikes along sensitive parameters, the presence server 104 has a more difficult time coping with a large number of events that come from the entities 105.

Some solutions to the above issues include the use of rate-limiting mechanisms and composition policies. However, these solutions may require the maintenance of a timer on a per subscriber and/or per watcher basis and processing of event aggregations in keeping with that timer.

The presence server 104 in one example breaks up the “continuous time” approach into discrete and finite time intervals such as “epochs” or “ticks”. The presence server 104 in this example groups the events and considers events that occur in each epoch as concurrent and coincident. Accordingly, the presence server 104 in this example supports a “discrete time” approach. The presence server 104 gathers events from the entities 105 during an epoch and determines if an update should be sent to the corresponding watchers 111 at an epoch boundary, as described herein.

In an alternative implementation, the entities 105 are configured to group the events before sending them to the presence server 104. This implementation may be used in the case of cascaded entities to the presence server 104.

Turning to FIG. 2, process flow 202 in one example comprises steps for handling events and updates between entities and watchers. The presence server 104 in one implementation performs the process flow 202. The presence server receives (STEP 204) events from the entities in continuous time (i.e., real-time or asynchronously) during an epoch. The presence server 104 computes (STEP 206) zero-sums of the events and discards any events that are moot in view of or in combination with other events. For example, if the entity 106 changes states several times during an epoch, only an aggregate or composite state across the epoch needs to be reported once, not as intermediate state changes during the epoch that were reversed. Receipt of the events continues until the end of an epoch (STEP 208). The presence server 104 then sends (STEP 210) updates to the watchers of the entities. In a single-node implementation (e.g., only one instance of the presence server), the presence server 104 then continues receiving events (STEP 204) in the following epoch. In another implementation where multiple presence servers are clustered together, the presence server 104 propagates (STEP 212) the events to the other presence servers (nodes) of the cluster before continuing into the next epoch.

The process flow 202 in one example provides for some “invariance across transients”. As the duration of the epoch is increased, less traffic is sent from the presence server 104 to the watchers 111, however the accuracy of the updates will be reduced. Accordingly, the presence server 104 in one example can adjust the epoch duration to control outbound traffic from the presence server 104. This provides similar stability as a rate-limiting implementation, but in contrast, provides benefit without requiring timer maintenance on a per subscriber or per watcher basis. For example, a single global node clock (e.g., on the presence server 104) is sufficient for all entities 105 and watchers 111.

In alternative implementations, multiple instances of the presence server 104 may be used, for example, in a clustered system of presence servers. In a server cluster implementation, different instances of the presence server 104 may communicate with one another to share information relating to incoming events that are potentially of interest to multiple nodes (i.e., other presence servers). The presence servers in one example are coupled by a shared communication bus. Accordingly, an incoming event on any one presence server is shared across the cluster of presence servers. In one example, the presence servers share the events with the other presence servers within the cluster in real-time, even though updates from each cluster node (presence server) to the watchers happen in discrete time. In another example, the presence servers are configured to share the event updates with the cluster upon the epoch boundary. If the presence servers in the cluster use the same epoch duration and the epoch boundaries are synchronized, there is a period of “quiet” monitoring as the presence servers receive event updates followed by a large increase in traffic at the epoch boundary. This effect can be reduced by skewing the epochs of the presence servers in the cluster. In the cluster configuration, the event messages from the entities 105 may be directed to a presence server based on a round-robin algorithm, a load balancing algorithm, statically assigned presence servers for each entity, or other selection methods, as will be appreciated by those skilled in the art.

In a further implementation of the clustered system, each presence server comprises a same epoch duration, but the epoch boundaries occur at different times (e.g., the presence servers comprise a clock skew or mesochronous clocks). This clock skew allows both local discrete time intervals among the presence servers of the cluster, but also for inter-nodal communication between the presence servers. For example, the clock skew provides time division allocation of a communication channel between the presence servers (such as a backplane, communication bus, or network interface that connects the presence servers). For example, no two presence servers send updates to the cluster at the same time.

In another implementation of the clustered system, the watchers 111 are categorized based on a priority level. The priority level in one example is selected based on a required or requested accuracy of the status variable and/or update messages for the entities 105. The priority level may also be selected based on cost of the update messages. In this implementation, the presence servers 105 comprise different epoch durations. For example, the presence server 404 comprises an epoch duration that is an integer multiple of an epoch duration of the presence server 406. In this example, a watcher 111 that requests a higher level of accuracy (e.g., higher priority) is assigned to the presence server 406 and a watcher 111 that requests a lower level of accuracy is assigned to the presence server 404.

The duration of an epoch may be static or dynamic. In one example, the duration is static and determined based on a configuration of the communication network 102. In another example, the presence server 104 dynamically determines the epoch duration. For example, the presence server 104 considers one or more of current network traffic load for the communication network 102, previous traffic patterns, status of the entities 105, status of the watchers 111, or other network factors. For example, the duration of the epoch may be between 100 nanoseconds, several seconds, minutes, or longer. The presence server 104 in one example determines the duration of the epoch upon a network trigger, for example, a trigger for a current network traffic load experienced by the presence server 104. In another example, the presence server 104 selects the duration of the epoch based on deployment characteristics of the communication network 102 such as peak time intervals for network activity, for example, the epoch duration is increased during a “busy hour”. In yet another example, the presence server 104 makes a determination of the duration of the epoch on a predetermined schedule, for example, every twenty minutes, every two hours, or other schedule, as will be appreciated by those skilled in the art. The predetermined schedule need not coincide with the epoch boundaries.

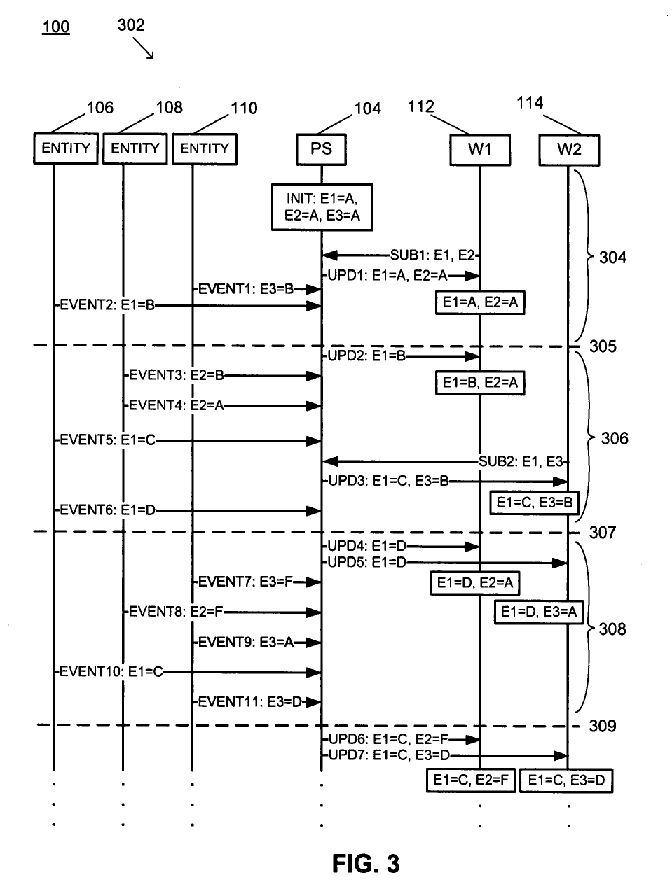

An illustrative description of operation of the apparatus 100 is presented, for explanatory purposes. Turning to FIG. 3, a message flow 302 in one example comprises event messages between the entities 106, 108, and 110 and the presence server 104, and also subscribe/update messages between the watchers 112 and 114 (W1 and W2, respectively) and the presence server 104. The watchers 112 and 114 send subscribe messages to the presence server 104 to request updates for the entities. In this example, the entities 106, 108, and 110 comprise status variables E1, E2, and E3, respectively. In this implementation, the presence server 104 initializes the status variables to a value of “A”.

FIG. 3 is divided into epochs 304, 306, 308, and 310 which are separated by epoch boundaries 305, 307, and 309. The presence server performs the initialization (INIT) of the status variables. The watcher 112 (W1) sends a subscribe message (SUB1) to the presence server 104 to request updates messages for status variables E1 and E2, which correspond to entities 106 and 108. Upon receipt of the subscribe message, the presence server 104 sends an update message (UPD1) to the watcher 112 with current values of the status variables (E1=A, E2=A). In one example, upon receipt of a subscribe message, the presence server 104 sends the first update message immediately to provide an initial value to the watcher. The presence server 104 sends further updates on the epoch boundaries, as described herein. In the remaining portion of the epoch 304, the presence server 104 receives event messages from the entity 108 (EVENT1: E3=B) and from the entity 106 (EVENT2: E1=B). At epoch boundary 305, the presence server 104 sends an update message (UPD2) to the subscribed watchers, i.e., watcher 112. In a first example, the presence server 104 sends only the status variables that have changed since the previous update (i.e., E1=B). In another example, the presence server 104 sends all “subscribed” status variables to the watcher 112 (e.g., E1=B and E2=A).

Within epoch 306, the presence server 104 first receives event messages (EVENT3 and EVENT4) from entity 108. Since EVENT3 changes the E2 variable from A to B, and EVENT4 changes E2 back to A, these two events sum to zero and cancel each other out. The presence server 104 receives EVENT5 from entity 106. The watcher 114 sends a subscribe message (SUB2) to the presence server 104 to subscribe to entities 106 and 110 (i.e., E1 and E3). The presence server 104 responds with an update message (UPD3) that comprises the current status of the variables (E1=C and E3=B). The presence server 104 then receives EVENT6 from entity 106 before the end of epoch 306. At the epoch boundary 307, the presence server 104 sends update messages (UPD4 and UPD5) to the watchers 112 and 114. Since EVENT3 and EVENT4 cancel each other out, in this example, no update is sent for the status variable E2.

The presence server 104 receives events from entities 106, 108, and 110 in epoch 308. Entity 110 sends three updates (EVENT7, EVENT9, EVENT11), where the latest update succeeds the previous. Entities 106 and 108 each send one update (EVENT10 and EVENT8). Accordingly, at the epoch boundary 309, the presence server 104 sends an update (UPD6) of E1 and E2 to the watcher 112 and an update (UPD7) of E1 and E3 to the watcher 114. In alternative examples, if no status variables require an update message to be sent or no watchers are subscribed, the presence server 104 determines that no update message should be sent and skips the update message for the corresponding epoch boundary.

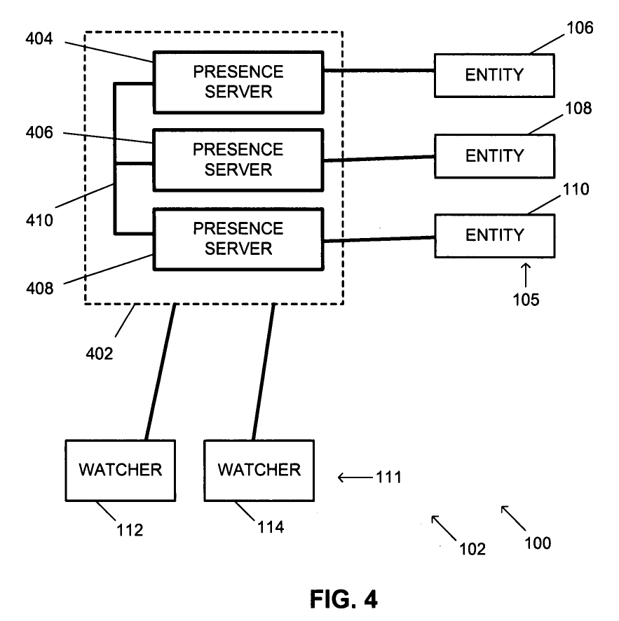

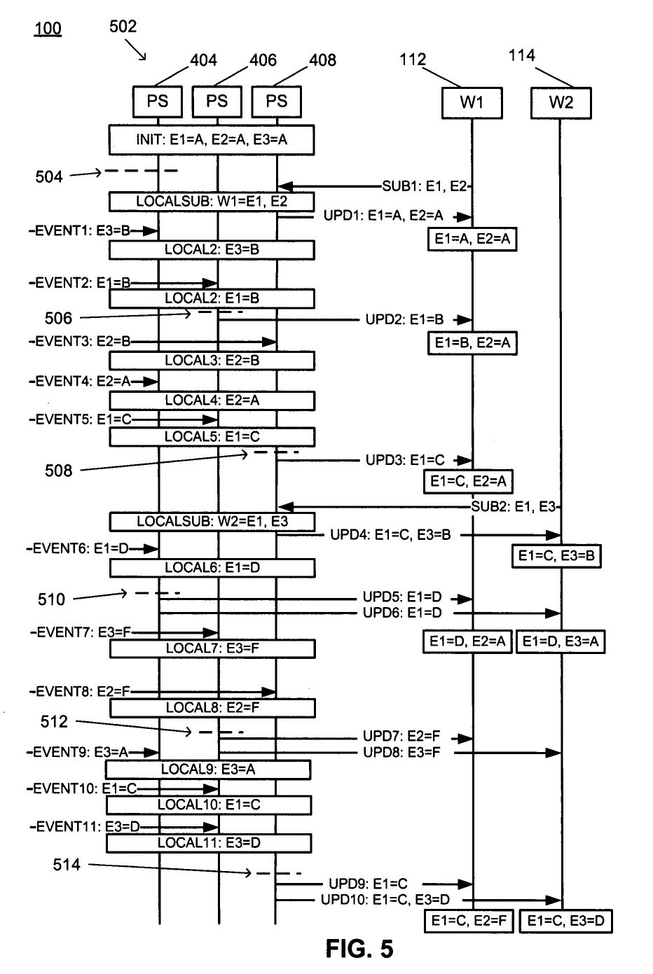

Turning to FIGS. 4 and 5, one implementation of a presence server cluster 402 comprises presence servers 404, 406, and 408, which are coupled by a communication bus 410. The presence server cluster 402 in this example receives event messages from the entities 105 and provides updates to the watchers 111. The presence servers 404, 406, and 408 in one example are analogous to the presence server 104. The communication bus 410 in one example is a shared communication path between the presence servers 404, 406, and 408. In a further example, the communication bus 410 is also shared with the entities 105 and the watchers 111, for example, where they are members of a local area network. Examples of the communication bus 410 comprise a backplane, internal communication bus, or a communication network (e.g., internet protocol network).

Referring to FIG. 5, the entities 105 are not shown for clarity purposes. In the example of FIG. 5, the event messages and subscribe messages are distributed to the presence servers 404, 406, and 408 with a round-robin mechanism by one or more routers (not shown) in the communication network 102 and the event and subscribe messages are shared by the presence servers 404, 406, and 408. In another example, the event messages are shared by the presence servers but each presence server maintains its own set of subscribed watchers.

The presence servers 404, 406, and 408 are mesochronous, for example, they comprise a same epoch duration, but the epoch boundaries at each presence server are skewed to occur at different times. Referring to message flow 502 for example, the duration of the epochs for presence servers 404, 406, and 408 is fifteen seconds and the local epochs are skewed by five seconds. Accordingly, in this example presence server 404 comprises epoch boundaries 504 and 510, presence server 406 comprises epoch boundaries 506 and 512, and presence server 408 comprises epoch boundaries 508 and 514. Upon receipt of an event message or subscribe message, the presence servers 404, 406, and 408 in this example immediately share the message with the other presence servers of the cluster. At their respective epoch boundaries, the presence servers 404, 406, and 408 send update messages to the watchers 112 and 114, as will be appreciated by those skilled in the art.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the apparatus 100 comprise the recordable data storage medium 116 of the entities 105 and the presence server 104. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a presence server configured to receive at least one event message from a network entity in continuous time;
wherein the presence server is configured to determine at discrete time intervals if an update message should be sent for the network entity;
wherein the discrete time intervals comprise instances of an epoch;
wherein the presence server is configured to determine if the update message should be sent upon an epoch boundary;
wherein the presence server is configured to dynamically determine a duration of the epoch.

2. The apparatus of claim 1, wherein the presence server is configured to dynamically determine the duration of the epoch upon a trigger for a current network traffic load experienced by the presence server.

3. The apparatus of claim 1, wherein the presence server is configured to receive a subscribe message for the network entity from a watcher;
wherein the presence server is configured to send the update message for the network entity to the watcher upon the epoch boundary.

4. The apparatus of claim 3, wherein the presence server, the network entity, and the watcher comprise a portion of a communication network;
wherein the presence server is configured to dynamically determine the duration of the epoch based on one or more of a peak traffic time of the communication network, previous traffic patterns of the communication network, or a configuration of the communication network.

5. The apparatus of claim 1, wherein the presence server is configured to receive at least one event message from a plurality of network entities in continuous time;
wherein the plurality of network entities comprise the network entity.

6. The apparatus of claim 1, wherein the presence server is configured to receive a plurality of subscribe messages for the network entity from a plurality of watchers;
wherein the presence server is configured to sends an instance of the update message to the plurality of watchers upon the epoch boundary.

7. The apparatus of claim 1, wherein the presence server is configured to compute zero-sum events and discard event messages, of the at least one event message that correspond to zero-sum events.

8. The apparatus of claim 1, wherein the presence server comprises a first presence server of a plurality of presence servers, wherein the plurality of presence servers comprise members of a presence server cluster;
wherein the first presence server is configured to send one or more update messages to other members of the presence server cluster in continuous time or upon the epoch boundary.

9. The apparatus of claim 8, wherein the plurality of presence servers further comprises a second presence server;
wherein the first presence server and the second presence server employ respective epochs with a same duration;
wherein a start of the epoch for the first presence server and a start of the epoch for the second presence server are skewed from each other.

10. The apparatus of claim 8, wherein the plurality of presence servers are coupled by a shared communication bus;
wherein the plurality of presence servers are mesochronous such that inter-server communication load over the shared communication bus is reduced.

11. A method, comprising the steps of:
receiving at least one event message from a network entity in continuous time during an epoch, wherein the epoch comprises a discrete time interval;
dynamically determining a duration of the epoch; and
determining if an update message should be sent for the network entity upon an epoch boundary of the epoch.

12. The method of claim 11, further comprising the step of:
receiving a subscribe message for the network entity from a watcher;
the method further comprising the step of:
sending the update message for the network entity to the watcher upon the epoch boundary.

13. The method of claim 11, further comprising the step of:
propagating the at least one event message to a presence server cluster in continuous time or upon the epoch boundary.

14. The method of claim 13, wherein the step of sending the update message comprises the step of:
sending the update message on a skewed schedule with the presence server cluster.

15. The method of claim 11, wherein the step of dynamically determining the duration of the epoch comprises the step of:
dynamically determining the duration of the epoch based on one or more of a peak traffic time of a communication network that comprises the network entity and the watcher, previous traffic patterns of the communication network, or a configuration of the communication network.

16. The method of claim 11, wherein the step of determining if the update message should be sent for the network entity upon the epoch boundary of the epoch comprises the steps of:
computing zero-sum events from the at least one event message during the epoch; and
discarding event messages, from the at least one event message, that correspond to zero-sum events during the epoch.

17. An article, comprising:
one or more computer-readable signal-bearing media; and
means in the one or more media for receiving a plurality of event messages from a network entity in continuous time during an epoch, wherein the epoch comprises a discrete time interval;
means in the one or more media for dynamically determining a duration of the epoch; and
means in the one or more media for determining if an update message should be sent for the network entity upon an epoch boundary of the epoch.

18. The article of claim 17, further comprising:
means in the one or more media for propagating the at least one event message to a presence server cluster in continuous time or upon the epoch boundary;
wherein the means for sending the plurality of update messages comprises:
means in the one or more media for sending the plurality of update messages on a skewed schedule with the presence server cluster.

19. The article of claim 18, further comprising:
means in the one or more media for receiving a subscribe message for the network entity from a watcher;
the article further comprising:
means in the one or more media for sending the update message for the network entity to the watcher upon the epoch boundary.

20. The article of claim 18, wherein the means for determining if the update message should be sent for the network entity upon the epoch boundary of the epoch comprises:
means in the one or more media for computing zero-sum events from the at least one event message during the epoch; and
means in the one or more media for discarding event messages, from the at least one event message, that correspond to zero-sum events during the epoch.
